(19) United States
(12) Patent Application Publication
(10) Pub. No.: US 2025/0138761 A1
(43) Pub. Date: May 1, 2025

(54) CLOUD-BASED SYSTEM AND METHOD FOR ON-SITE PHOTO CAPTURE, ENHANCEMENT, AND PRINTING FOR EVENTS

(71) Applicants: Osher VATARI, Washington, DC (US); Yoav BAR ASHER, Washington, DC (US)

(72) Inventors: Osher VATARI, Washington, DC (US); Yoav BAR ASHER, Washington, DC (US)

(21) Appl. No.: 18/946,171

(22) Filed: Nov. 13, 2024

Related U.S. Application Data
(63) Continuation-in-part of application No. 18/820,177, filed on Aug. 29, 2024.
(60) Provisional application No. 63/535,289, filed on Aug. 29, 2023.

(51) Int. Cl. G06F 3/12; G06F 9/451; G06T 11/60

(52) U.S. Cl. CPC G06F 3/1237; G06F 3/1204; G06F 3/1285; G06F 9/451; G06T 11/60

(57) ABSTRACT

A distributed photo capture and printing system for events is disclosed. The system comprises a cloud-based server infrastructure, a web-based application accessible via mobile devices, and dedicated printing stations. It leverages guests' own mobile devices for distributed photo capture, eliminating queues and allowing parallel photo taking throughout the event space. The system offers real-time photo enhancement, including digital prop additions and AI-powered modifications. A multi-tiered management interface caters to administrators, providers, operators, and hosts, providing role-specific functionalities. The printing process is optimized through load balancing across multiple stations, with real-time status updates for guests. The system's modular architecture allows for flexible deployment scenarios, from cloud-based to on-premise solutions, and easy integration with third-party services. This invention represents a scalable, efficient alternative to traditional photo booths, enhancing guest experiences while providing valuable insights to event organizers.

### CROSS REFERENCE TO RELATED APPLICATIONS

This application is a Continuation-in-Part of U.S. patent application Ser. No. 18/820,177, filed Aug. 29, 2024, which claims the benefit of priority of U.S. Provisional Patent Application No. 63/535,289, filed Aug. 29, 2023, the contents of which are all incorporated herein by reference in their entirety.

### FIELD OF INVENTION

The present invention relates generally to the field of event photography and image processing systems. More specifically, the invention pertains to a distributed, scalable system for on-site photo capture, enhancement, and printing at events, leveraging the guests' mobile devices and cloud-based technologies to provide a flexible and efficient alternative to traditional photo booths.

### BACKGROUND

In recent years, photo booths have become a popular attraction at various events, including weddings, corporate gatherings, and social celebrations. These traditional photo booths typically consist of an enclosed or semi-enclosed space where attendees can take photos, often with props or themed backdrops. While photo booths offer a fun, interactive experience for guests, they come with several limitations.

One significant drawback of conventional photo booths is their limited capacity. Only a small number of guests can use the booth at any given time, often resulting in long queues and wait times. This can lead to frustration among event attendees and may result in some guests missing out on the photo opportunity altogether.

Another limitation is the need for dedicated personnel to operate and manage the photo booth throughout the event. This not only adds to the overall cost but also introduces potential issues if the operator needs to take breaks or if technical problems arise.

Traditional photo booths are also constrained by their physical location within the event space. Guests must leave their current activities and move to the booth's location to participate, which can disrupt the natural flow of the event and limit spontaneous photo opportunities.

Furthermore, the scalability of traditional photo booth setups is limited. For larger events, multiple booths might be required, significantly increasing the space needed, the costs and logistical complexity.

In light of these limitations, there is a growing need for a more flexible, scalable, and efficient solution that can provide similar or enhanced photo capture and printing capabilities without the constraints of traditional photo booths.

The present invention addresses these challenges by introducing a distributed system that leverages guests' own mobile devices for photo capture, cloud-based technologies for image processing and management, and strategically placed printing stations for on-demand photo retrieval. This approach eliminates the need for dedicated booth operators, allows for parallel photo capture and enhancement by multiple guests regardless of their location within the event space, and significantly reduces or eliminates queues for photo taking and printing.

By utilizing a cloud-based architecture, the system offers unprecedented scalability, easily accommodating events of various sizes with minimal need for additional physical infrastructure. The system's ability to provide real-time status updates on print jobs further enhances the guest experience, allowing attendees to continue enjoying the event while their photos are being processed and printed.

Additionally, the integration of advanced features such as virtual frames, AI-powered image enhancements, and customizable templates offers a level of personalization and creativity that surpasses the capabilities of traditional photo booths.

In summary, the present invention represents a significant advancement in event photography systems, offering a more flexible, efficient, and engaging solution that addresses the limitations of conventional photo booths while providing enhanced functionality and scalability for event organizers and attendees alike.

Prior art in this field includes various attempts to modernize and distribute the photo-capturing experience at events. Some solutions have involved networked kiosks placed throughout an event space, allowing guests to take photos at multiple stations. While this approach addressed some limitations of traditional photo booths, it still required significant hardware investment and setup.

Mobile photo-sharing apps including “virtual photo booth” apps, have also emerged as a way for event attendees to capture and share moments. These apps typically allow users to upload photos to a shared album or feed, sometimes with basic editing features. However, these solutions often lack integration with on-site printing capabilities.

Some event organizers have experimented with providing guests with disposable cameras or renting out digital cameras. While this approach distributes photo-taking capabilities, it introduces logistical challenges in collecting and processing the cameras, and doesn't offer real-time sharing or editing features.

While there are mobile apps that allow users to order prints of their photos, these solutions typically involve off-site printing and delivery, rather than immediate on-site printing at events. Some photo-sharing apps allow event attendees to contribute to shared albums, but they generally lack integration with on-site printing capabilities. This gap in the market highlights the need for a solution that combines the convenience of smartphone photography with immediate, high-quality print output at event venues.

Recently, some photo booth manufacturers have introduced models that allow guests to connect their smartphones to the booth, either via a physical connection or wirelessly. These systems enable users to print photos taken with their own devices, offering more flexibility than traditional photobooths. While this represents a step forward in event photography, these solutions still face certain limitations. They typically require guests to physically approach the booth to initiate printing, which can lead to queues during busy periods. The scalability of these systems is also limited, as adding more booths to accommodate larger events can be costly and space-intensive. Furthermore, while these booths allow for smartphone connectivity, they often lack features such as real-time cloud-based editing, AI-enhanced image processing, or the ability for guests to manage their print jobs remotely.

Some event photography systems have emerged that utilize cloud technology for photo capture and management. While these represent a step forward in leveraging cloud capabilities, they still have limitations. These systems are typically dependent on a provided device(s) for capturing images, rather than utilizing guests' own smartphones. While they allow integration with printers, this often requires setup by the event organizers. As such, these solutions are not yet fully developed or “baked” into a seamless, end-to-end system that can be easily deployed and scaled for various types of events.

Despite these advancements, there remains a need for a comprehensive system that fully leverages the capabilities of modern smartphones, cloud computing, and AI technologies to provide a seamless, scalable, and feature-rich event photography experience. The present invention aims to address this gap in the market by offering a solution that combines the best aspects of distributed photo capture, real-time editing and enhancement, efficient printing management, and social sharing capabilities.

### SUMMARY OF THE INVENTION

The present invention provides a comprehensive, scalable system for on-site photo capture, enhancement, and printing at events, leveraging cloud-based technologies and mobile devices to offer a flexible alternative to traditional photo booths.

The system architecture comprises three main components: a centralized server infrastructure, distributed printing stations, and a web-based application accessible through mobile devices. The infrastructure implements separate authentication mechanisms for event guests and system management.

The printing station component comprises a computing device and a photo printer capable of producing high-quality prints on various media types. These stations can be deployed either as permanent installations or portable units.

The system implements a hierarchical access control system with distinct roles:
1. Administrator: System-wide oversight and management capabilities
2. Provider: Management of equipment, events, and user access
3. Host: Event-specific configuration and customization
4. Operator: Optional role for on-site system management
5. Guest: End-user access to photo capture and printing features

The invention supports four distinct provider types, each with unique operational models:
1. Venue: Maintains permanent station(s) at a fixed location
2. Freelancer: Owns portable station(s) for deployment at various event locations
3. Limited Freelance: Operates without a dedicated printing station, managing their own printing solutions and utilizing the event gallery for image downloads
4. Business: Employs a printing station for continuous operation, not necessarily event-based

Key features of the system include:
1. System Administration:
   a. Management of printing stations and events
   b. User role-based access control
   c. Real-time monitoring of equipment status
   d. Automated consumables tracking and ordering
   e. Usage and performance analytics
2. Event Operations:
   a. On-demand printing with status tracking
   b. Real-time equipment monitoring and alerts
   c. Load balancing across multiple printing stations
3. Host Features:
   a. Guest list management with automated communications
   b. Event-specific customizable photo frames
   c. Event photo collection management
   d. Event configuration and customization
4. Guest Features:
   a. Web-based mobile access via links or QR codes
   b. Personal photo galleries
   c. Digital prop, frame additions and optional AI enhancements.

The system is designed for operational efficiency, minimizing administrative overhead while maintaining robust functionality. Event setup requires minimal configuration, primarily focusing on customization options and optional guest management.

This system represents a significant advancement in event photography, offering a scalable, user-friendly solution that enhances guest experiences while streamlining operations for venues and event organizers. Its cloud-based architecture ensures easy updates and feature expansions, including planned integrations with generative AI for enhanced photo editing capabilities.

### BRIEF DESCRIPTION OF THE FIGURES

FIG. 1 illustrates the overall system architecture of the present invention, depicting a distributed photo capture and printing system that transforms traditional photo booth limitations into a scalable solution. The system's architecture enables parallel photo capture and printing operations while maintaining system reliability and performance at scale.

FIG. 2 is a detailed flow diagram that illustrates the guest interaction process within the system, from initial access through photo capture and processing to final output retrieval.

FIG. 3 is a detailed flow diagram that illustrates the event print queue and server flow.

FIG. 4 is a detailed flow diagram of the management and operational aspects of the disclosed system.

### DETAILED DESCRIPTION OF THE INVENTION

### Overall Structure

The present invention provides a system and method for distributed photo capture and printing at events, utilizing guests' mobile devices and one or more printing stations to enable parallel photo operations throughout an event space. The following detailed description presents various implementations and examples of the system, with reference to the accompanying figures.

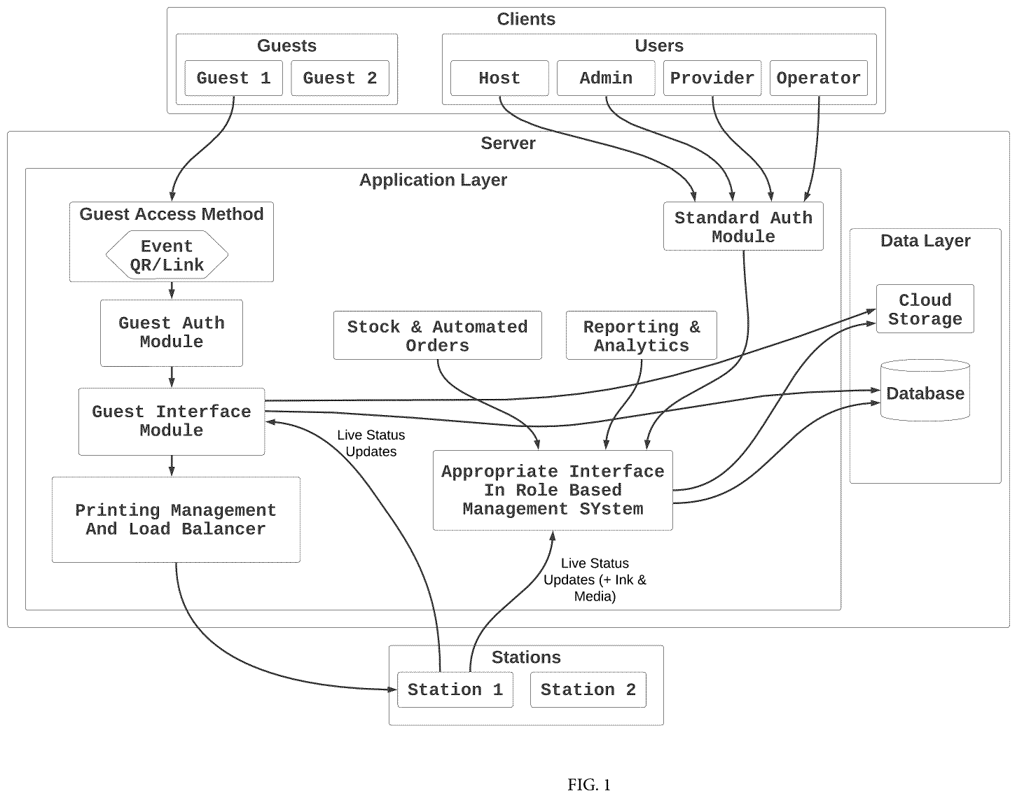

FIG. 1 illustrates the overall system architecture of the present invention, depicting a distributed photo capture and printing system that transforms traditional photo booth limitations into a scalable solution. The system's architecture enables parallel photo capture and printing operations while maintaining system reliability and performance at scale.

As shown in FIG. 1, the system comprises three main components: (1) a client layer including one or more guests and system users, (2) a server layer with both application and data components, and (3) one or more printing stations. This distributed architecture enables the system to overcome the physical constraints of traditional photo booths by virtualizing the photo capture process while maintaining centralized control over printing operations.

The client layer includes two distinct user groups: Guests FIG. 1. (G1, G2) who capture and print photos, and system Users including Operators (optional), Providers, Administrators, and Hosts. Each user type interacts with the system through role-specific interfaces, providing comprehensive event photography management.

The server layer comprises an Application Layer and a Data Layer, as illustrated in FIG. 1. The Application Layer includes several specialized modules: —Guest Auth Module for guest authentication —Standard Auth Module for system user authentication —Role Based Management System for access control —Guest Interface Module for photo capture and manipulation —Printing Management and Load Balancer for optimized print distribution —Reporting & Analytics for system monitoring —Stock & Automated Orders for consumables management

The Data Layer maintains a Database and Cloud Storage for efficient data management and image storage. This separation of concerns enables scalable operation while maintaining system reliability.

The printing station layer comprises one or more Print Stations FIG. 1. (PS1, PS2), each capable of operating independently while maintaining real-time communication with the server layer. This distributed printing architecture allows for flexible deployment scenarios, from single-station setups to multi-station configurations.

A key feature of the system is its ability to manage parallel operations through the Printing Management and Load Balancer module, which distributes print jobs across available stations while maintaining real-time status updates to both system users and guests.

The system provides access for guests through QR Codes or Event Links, connecting them to the virtual photo booth experience through the Guest Auth Module.

Live Status Updates are maintained between Print Stations and both the Guest Interface and Role Based Management System, ensuring real-time visibility of system operation and print job status. This bidirectional communication includes critical information about ink and media levels, enabling proactive system management.

### Guest Flow And Interface

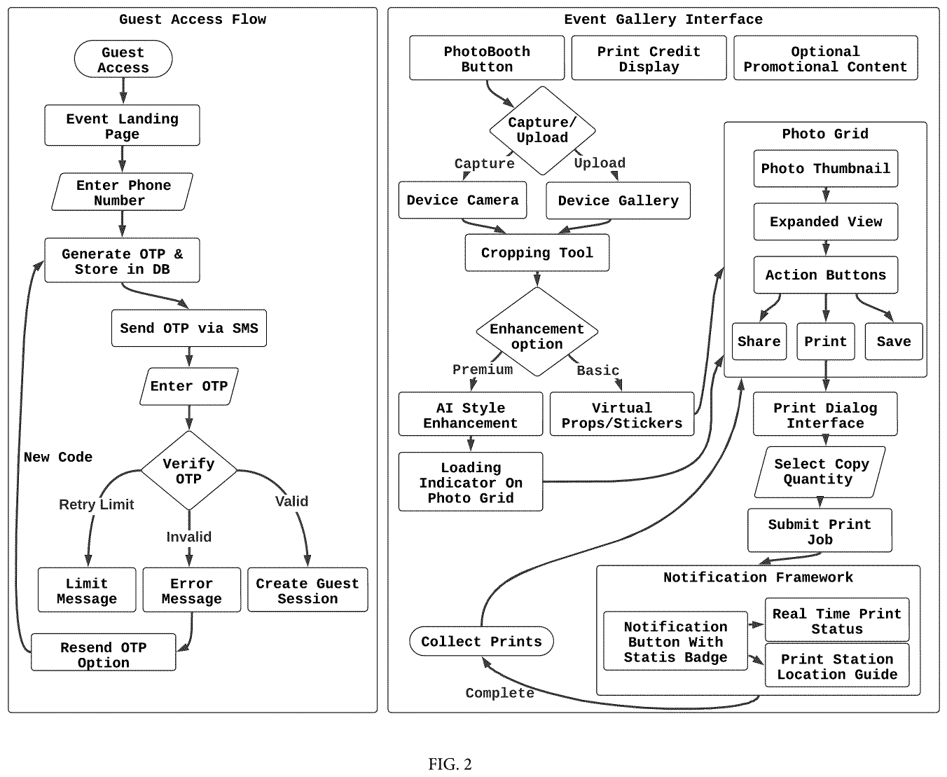

Guest Access and Initial Interaction: Referring now to FIG. 2, a detailed flow diagram illustrates the guest interaction process within the system, from initial access through photo capture and processing to final output retrieval. Guest access is initiated through either: a) scanning an event-specific QR code; or b) following an event-specific URL link. Both methods direct the guest to the Event Landing Page. This landing page serves as the entry point to the photo booth experience.

Guest Authentication and Session Management: The guest authentication process, designed to be secure and user-friendly, comprises the following steps:
a) Phone Number Input: The Event Landing Page prompts the guest to enter their phone number using a visually appealing and intuitive input field. This input field leverages an international telephone input library, enabling automatic formatting and country code selection for a global audience. This simplifies the input process and minimizes errors. The input field also provides validation feedback to the user ensuring correct number formats are submitted.
b) OTP Generation and Storage: Upon receiving the guest's phone number, the system generates a unique, time-sensitive, one-time password (OTP). This six-digit numeric code is then stored securely in the system's database, associated with the guest's phone number and an expiration timestamp.
c) OTP Transmission: The generated OTP is transmitted to the guest via SMS message to their provided phone number. The SMS message includes information about the time validity of the code, and a link to the website.
d) OTP Input and Verification: The Event Landing Page dynamically updates to display an OTP input field. This visually distinct field guides the guest to enter the six-digit code received via SMS. The input field is divided into six individual cells, each accepting a single digit, for improved user experience and clarity. The system supports automatic OTP detection.
e) OTP Verification and Error Handling: The entered OTP is verified against the stored value and its expiration time in the database. The system implements robust error handling comprising:
   i. OTP Resend Option: If the OTP expires, the system provides a clear “Resend OTP” option, allowing the guest to request a new code without re-entering their phone number.
   ii. Invalid OTP Message: If an invalid OTP is entered, a clear and concise error message is displayed, prompting the guest to re-enter the code.
   iii. Retry Limit Enforcement: To prevent brute-force attacks, a maximum retry limit is enforced.
f) Guest Session Creation: Upon successful OTP verification, a guest session is created within the system. This session is associated with the guest's phone number and relevant event information, and access tokens are generated to facilitate secure and personalized access to the event gallery and photo booth features.

Event Gallery Interface and Features: Following successful authentication, the system presents the guest with a dynamic and interactive Event Gallery interface. This interface is designed for both engagement and ease of use, providing access to captured photos, photo booth functionality, and print management tools. The interface comprises the following key elements:
a) Print Credit Display: A persistent display of the guest's remaining print credits is prominently displayed, providing clear visibility. This display dynamically updates whenever a print job is submitted or completed, ensuring the guest is always aware of their remaining print allowance.
b) Photo Grid Display: A chronologically ordered grid display showcases all photos captured or processed by the guest during the event. Each photo is presented as a thumbnail within the grid, arranged to maximize visibility and facilitate browsing. Tapping a thumbnail expands the photo to a larger view with associated action buttons. The grid dynamically updates as new photos are added.
c) Optional Promotional Content Integration: The system offers the flexibility to incorporate promotional content within the Event Gallery interface. This content, such as banner advertisements, sponsored messages, venue promotions, or event sponsor branding, can be strategically placed within the interface layout to maximize visibility and engagement. The system allows for dynamic control over promotional content, enabling targeted messaging and adjustments throughout the event.
d) Photo Action Buttons: Each photo displayed in the grid, when expanded, is accompanied by three distinct action buttons:
   i. Download Button: This button enables the guest to directly download the selected photo to their device. The download functionality optimizes the image format and resolution for optimal storage and sharing.
   ii. Share Button: This button allows the guest to share the selected photo through various social media platforms or via email directly from the interface. Sharing options are dynamically populated based on the guest's device capabilities and installed applications.
   iii. Print Button: This button triggers a Print Dialogue Interface (described in detail in section [0071]), enabling the guest to submit a print request for the selected photo.
e) Photo Capture/Upload Button: A clearly labeled and visually prominent button initiates the Photo Booth Interface, allowing the guest to either capture a new photo using their device's camera or upload an existing photo from their device's gallery.
f) Notification Button and Interface: A dedicated notification button provides access to real-time print job status updates and print station information.
   i. Real-Time Print Job Status: Upon submitting a print request, the notification interface provides continuous updates on the job's status. These updates include confirmation of job receipt, a progress bar visually indicating print progress, completion notifications, and error messages if applicable.
   ii. Print Station Location Visualization: The notification interface displays images of the print stations at the event, providing a visual reference point for guests.
   iii. Print Station Location Description: Clear textual descriptions accompany the station images, further clarifying the station's physical location within the event venue for easy print retrieval. These descriptions can be customized by the event organizer for accurate and detailed guidance.

Notification Framework for Real-time Updates: The system incorporates a comprehensive notification framework to keep guests informed about the status of their print jobs and provide clear guidance for print retrieval. This framework consists of:
a) Notification Button: An always-visible notification button, featuring a bell icon, serves as a persistent indicator of pending notifications. The button dynamically updates with a colored badge displaying the number of pending print jobs, providing a clear visual cue to the guest. The badge color corresponds to the status of the print jobs (e.g., blue for processing, green for completed, yellow for paused, red for failed).
b) Real-Time Print Job Status Updates: Clicking the notification button opens a dedicated Notification Interface, providing detailed, real-time updates on all pending print jobs. This includes:
   i. Job Received Confirmation: Upon successful submission, the interface confirms that the print job has been received by the system.
   ii. Processing Status with Progress Indication: A dynamic progress bar visually represents the print job's progress in real-time. The progress bar is accompanied by an estimated time to completion, calculated based on the number of copies requested and the current queue length at the designated print station.
   iii. Completion Notification: Upon successful completion of the print job, the notification interface displays a clear message, prompting the guest to retrieve their prints.
   iv. Error Notifications: In the unlikely event of a print job error (e.g., printer malfunction, paper jam), the notification interface displays a concise error message.
c) Print Station Location Guidance: The Notification Interface provides comprehensive visual and textual guidance to assist guests in locating the print station:
   i. Photographic Representation of the Station: A clear photograph of the print station is displayed, allowing guests to visually identify the station within the event venue.
   ii. Descriptive Text of Station Location: A detailed textual description accompanies the station photograph, providing precise directions to the station. This description can be customized by the event organizer to include specific landmarks or instructions tailored to the event.

Photo Booth Interface for Image Capture and Enhancement: Selecting the photo capture/upload button from the Event Gallery Interface transitions the guest to the Photo Booth Interface. This dedicated interface empowers guests to create and personalize their photos through a streamlined and engaging process. The Photo Booth Interface offers the following functionalities:
a) Image Capture: Guests can capture new photos directly through their device's camera. The interface integrates seamlessly with the device's camera functionality, providing a live preview and controls for capturing the perfect shot. The implementation accounts for device-specific camera capabilities.
b) Image Upload: Guests can upload existing photos from their device's gallery. The interface provides a standard file selection dialogue, allowing guests to choose photos from their local storage. The interface includes validation checks for file size and type.
c) Image Cropping: After capturing or uploading a photo, the interface transitions to a cropping tool. This cropping tool allows guests to adjust the photo's framing and aspect ratio to fit pre-defined template sizes (e.g., 4×6 inches) and can overlay custom frames provided by the event host. The cropping tool provides intuitive controls, such as pinch-to-zoom and drag-to-reposition, for precise adjustments. A live preview of the cropped area is displayed, allowing the guest to see the final composition before proceeding. Additionally, a rotate button enables guests to rotate the image in 90-degree increments to correct orientation or for creative purposes.
d) Image Enhancement Options: After the image crop, the system provides up to two image enhancement options based on the selected package's features:
   i. Virtual Props/Stickers: All packages offer a library of virtual props and stickers for guest use. These are presented in a categorized grid within the user interface. Guests can select, position, resize, and rotate multiple props and stickers on their photos using touch gestures. Upon selection of a sticker, controls appear, including buttons for scaling/rotation, mirroring, and removal. Dragging a sticker allows for repositioning within the photo.
   ii. AI-Style Enhancement (Package Dependent): When AI-style enhancement is included in the event's selected package, guests have the option of choosing AI-driven style modifications for their photos as an alternative to the virtual props/stickers.
e) Image Storage: After the guest's photo is finalized, the processed image is transmitted to the server. The server stores the image in cloud storage and generates a unique, protected URL for access and retrieval, rather than directly storing the image data on the guest's device.

AI-Style Image Enhancement and Processing: When AI-style enhancement is a feature of the selected event package, the Photo Booth Interface provides guests with access to this advanced functionality. The process unfolds as follows:
a) Style Selection and Loading Indicator: The guest selects a desired AI style from the available options within the Photo Booth Interface. Upon completion, a loading indicator is displayed prominently over the image within the gallery interface. This visual cue informs the guest that their photo is being processed.
b) Image and Parameter Transmission: The system transmits the original image, along with the selected AI style parameters, to a dedicated external AI processing server. This transmission is optimized for efficiency and reliability, minimizing latency and ensuring image integrity.
c) AI Processing and Image Return: The AI server processes the received image according to the specified style parameters. This processing may involve applying filters, artistic effects, background transformations, or other AI-driven modifications, while maintaining the subject's identity and overall image quality. The AI server then returns the processed image to the system.
d) Processed Image Display: Upon receiving the processed image from the AI server, the system seamlessly replaces the loading indicator with the enhanced photo within the gallery. The guest can then review the final image and proceed with further actions, such as downloading, sharing, or printing.

Share and Download Options with Promotional Integration: The system offers flexible share and download options within the Photo Booth Interface, allowing guests to easily distribute and save their personalized photos. These options can be further enhanced with promotional elements to meet the requirements of the provider, host, or sponsors.
a) Embedded Promotional Content: Upon selecting the share or download options, the system can dynamically embed promotional content within the final image. This content can include branded frames, watermarks, event-specific links or text, sponsor logos, or other promotional elements defined by the event provider. The system provides granular control over the placement, size, and appearance of these promotional elements.
b) Branded Frames and Watermarks: Beyond simply embedding content, the system can apply branded frames or watermarks to the images before sharing or downloading. These frames or watermarks can be customized with event logos, sponsor branding, or other visual elements that reinforce event identity or promotional messages.
c) Event-Specific Links and Text: The shared or downloaded images can include event-specific links or text, such as the event website, social media hashtags, or promotional codes. This functionality further extends the reach of the event and provides guests with easy access to relevant information.

Print Dialogue Interface and Print Management: The print functionality is a core feature of the system, allowing guests to obtain physical copies of their favorite photos. This process is initiated through the print button within the Event Gallery Interface, which triggers the following steps:
a) Print Dialogue Interface: A user-friendly print dialogue interface is presented to the guest. This interface comprises:
   i. Available Print Credit Display: The guest's remaining print credits are clearly displayed within the dialogue, reminding them of their print allowance. This display dynamically updates as prints are requested, providing real-time feedback.
   ii. Copy Quantity Selection Interface: An intuitive interface allows the guest to select the desired number of copies for their print. This interface may use increment/decrement buttons or a numerical input field with clear validation rules to prevent exceeding the available print credits or any imposed print limits. Real-time feedback is provided if the requested copies exceed available credits.
   iii. Confirmation Button: A confirmation button finalizes the print request, submitting it to the system for processing.
b) Print Request Submission and Management: Upon confirmation, the print request is submitted to a dedicated print management module. This module handles the queuing, routing, and monitoring of print jobs, ensuring efficient processing and distribution to the designated print station. The module incorporates load balancing and failover mechanisms to optimize print throughput and ensure reliability across multiple print stations (if available). This will be described in more detail in a later section.
c) Real-Time Status Updates: The system provides real-time status updates to the guest regarding their print job via the Notification System. This ensures transparency and keeps the guest informed throughout the printing process.
d) Optional SMS Notification: As an optional feature, the system can send an SMS message to the guest's phone number upon successful completion of their print job. This notification informs the guest that their prints are ready for collection at the designated print station. The SMS message may also include the location description of the print station as a reminder.

Session Persistence and Dynamic Interface Adaptation: The system is designed for a seamless and personalized user experience. This is achieved through session persistence and dynamic adaptation of interface elements based on various factors.
a) Session Persistence: The system maintains guest session persistence throughout the event duration. This enables continuous access to the Event Gallery, allowing guests to browse photos, submit multiple print requests, and track the status of concurrent print jobs without needing to re-authenticate. Session persistence is managed securely through access tokens and session timeouts to ensure data privacy and prevent unauthorized access.
b) Dynamic Interface Adaptation: The system intelligently adapts interface elements based on several real-time factors:
   i. Available Print Credits: Interface elements related to printing, such as the print button and copy quantity selection, are dynamically enabled or disabled based on the guest's remaining print credits. This prevents print requests that exceed the allowed limit and provides clear feedback to the guest.
   ii. Event-Specific Customizations: The interface is customized to reflect event-specific branding, themes, and messaging. This may include custom backgrounds, logos, fonts, and color schemes, creating a cohesive and immersive experience for the guest.
   iii. Package-Dependent Feature Availability: The Photo Booth Interface dynamically adjusts the availability of features, such as AI-style enhancements, based on the features included in the event's selected package. Features not included in the package are gracefully hidden or disabled, preventing guest confusion.
   iv. Active Promotional Requirements: The system dynamically integrates optional promotional content based on the requirements. This ensures that relevant promotions are displayed at the appropriate times and locations within the interface.
   v. Print Station Availability: The system monitors the real-time status of print stations. If a print station becomes unavailable (e.g., offline, out of paper), the notification system alerts guests and the print functionality within the interface may be temporarily disabled or rerouted to available stations, ensuring a smooth and uninterrupted user experience.

### Printing Station Architecture and Operation

Each printing station, functioning as a self-contained unit within the broader system, is comprised of the following essential components:
a) Computing Device: The computational heart of the station, responsible for executing the station software and managing communication with the server and printer. This device includes:
   i. Processor: A central processing unit (CPU) capable of executing instructions and performing calculations necessary for station operation. This can range from a low-power embedded processor to a more powerful desktop-grade CPU, depending on the specific requirements of the station.
   ii. Memory: Random access memory (RAM) and persistent storage (e.g., hard drive or solid-state drive) for storing the station software, image data, print job queue, and operating system.
   iii. Network Connectivity Capabilities: Wi-Fi or Ethernet connectivity for establishing and maintaining a continuous, bi-directional communication link with the central server. This connectivity is crucial for receiving print jobs, sending status updates, and receiving commands from the server.
   iv. Printer Connection Interface: A USB or other appropriate interface (e.g., parallel, serial) for connecting to the photo printer. This interface enables the computing device to send print data and control commands to the printer.
b) Photo Printer: A dye-sublimation or inkjet printer capable of producing high-quality physical prints of captured images. The printer must be compatible with the chosen media type (see below) and capable of receiving commands from the station's computing device. Print quality and speed are important considerations in printer selection.
c) Station Software: Specialized software residing on the computing device, responsible for managing all print operations. This software is detailed in subsequent sections and forms a key aspect of the invention.

The printing station exhibits versatility in its media handling, accommodating various media types to cater to different event needs and printer capabilities. The supported media types include:
a) Photo Paper: Standard glossy or matte photo paper is the primary media type, providing a cost-effective and readily available option for producing high-quality prints. The specific paper size and finish can be configured according to the event requirements and printer capabilities.
b) Magnetic Media: Optionally, the station can be configured to utilize magnetic media. This specialized media is designed to adhere to ferromagnetic surfaces, offering guests a unique and interactive way to display their prints. Support for magnetic media is contingent upon:
   i. Printer Hardware Capabilities: The printer must be specifically designed to handle and print on magnetic media. This includes appropriate feed mechanisms and print head compatibility.
   ii. Selected Event Package: The event package chosen by the host may include or exclude the magnetic media option, influencing its availability at the station.
   iii. Current Media Configuration at the Station: The station operator must physically configure the printer with magnetic media for it to be available as a print option. The station software can reflect this configuration and present the appropriate options to the guests.

The station software, a crucial component of the invention, employs a modular, layered architecture that facilitates flexibility, maintainability, and adaptability to diverse printer models. This architecture consists of three primary layers:
a) Communication Layer: This layer is the interface between the station and the central server, responsible for secure and reliable data exchange. Its core functions include:
   i. Establishing and Maintaining Server Connection: A secure, authenticated channel ensures both the server and the station authenticate each other, preventing unauthorized connections and protecting sensitive data transmitted during communication. This connection persists throughout the event duration, enabling real-time communication.
   ii. Receiving Print Job Requests and Commands: This layer listens for incoming messages from the server, interpreting and parsing print job requests (including image URLs and print settings) and commands for station control (e.g., pause/resume, eject media, printer maintenance, etc.).
   iii. Sending Status Updates and Acknowledgments: Transmitting real-time status updates to the server, including printer status, queue length, consumable levels, and job completion acknowledgments. These updates allow the server to monitor the station's operational state and make informed load balancing decisions.
   iv. Implementing Real-time Bi-directional Communication Protocol: The communication protocol facilitates a persistent, bi-directional communication channel between the station and the server. This allows for immediate feedback and control, enabling dynamic adjustments to print operations based on real-time conditions.
b) Job Management Layer: This layer acts as the orchestrator of print tasks within the station. Key responsibilities include:
   i. Managing Print Job Queue: Maintaining an ordered queue of print jobs received from the server. The queue is managed in a thread-safe manner to ensure data integrity and prevent race conditions in a multi-threaded environment.
   ii. Handling Job Processing Logic: Controlling the flow of print jobs through the system, including queuing, prioritizing, and dispatching jobs to the Printer Control Layer.
   iii. Downloading and Preparing Print Data: Retrieving image data from the provided URLs and preparing the data for printing. This may involve image format conversions, resizing, or other manipulations to optimize for the specific printer.
   iv. Monitoring Overall System Status: Continuously monitoring the status of the printer, queue, and system resources to ensure optimal operation.
   v. Implementing Persistent Storage for Job Statuses: Utilizing a local persistent storage (e.g., SQLite database) to maintain a persistent record of job statuses. This allows the station to recover from unexpected interruptions (e.g., power outage, software crash) and resume printing from the last known state.
c) Printer Control Layer: This layer interacts directly with the printer hardware. Its modular design allows for easy adaptation to different printer models. This layer's functions include:
   i. Communicating with Printer Hardware: Sending print data and control commands (e.g., print, pause, clean) to the printer via the appropriate interface.
   ii. Monitoring Printer Status: Retrieving printer status information (e.g., online/offline, ink levels, errors) and reporting it to the Job Management Layer.
   iii. Executing Print Commands: Translating generic print requests into printer-specific commands and executing them on the printer hardware.
   iv. Handling Printer-Specific Maintenance Tasks: Performing printer maintenance functions such as cleaning cycles, calibration, and firmware updates. These tasks can be triggered by commands from the server or scheduled automatically by the station software.

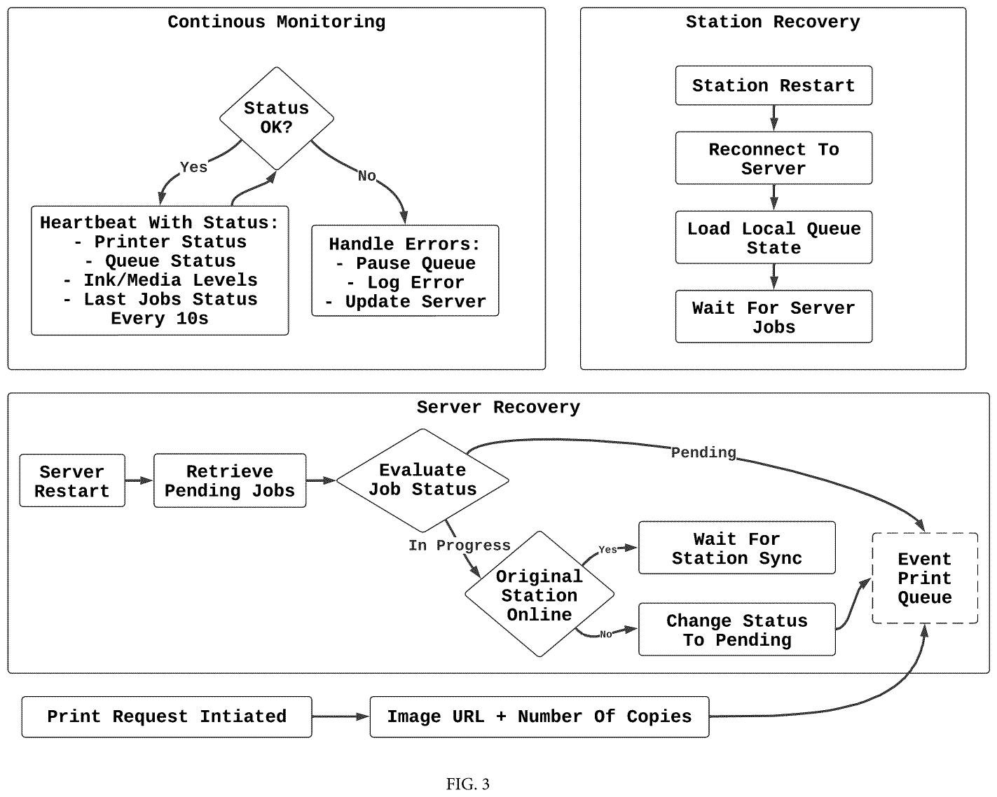

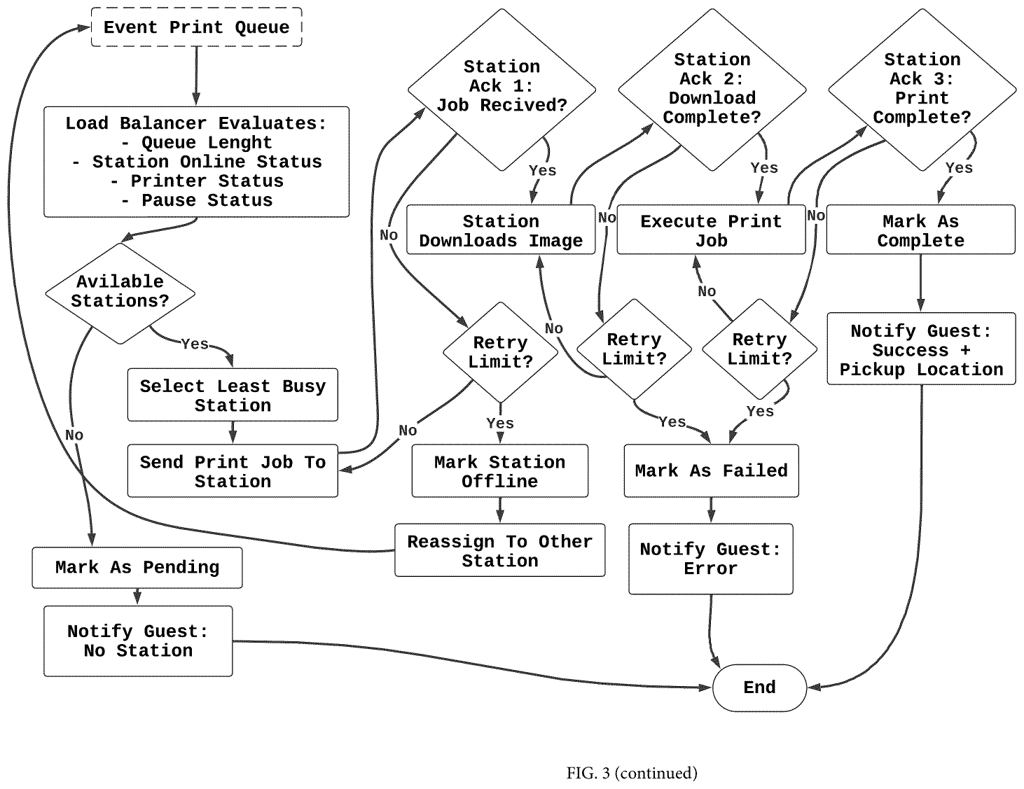

The print request handling process, a core aspect of the invention, is a robust, distributed procedure orchestrated by the server and executed by the selected printing station. This process, designed for efficiency, fault tolerance, and real-time feedback, is detailed below (shown in the main flow of FIG. 3):
a) Print Request Initiation: A guest initiates a print request via their mobile device, specifying the desired number of copies. This request, along with the guest's ID and event ID, is transmitted to the cloud-based server.
b) Server-Side Queueing and Load Balancing: The server receives the print request and adds it to a queue dedicated to the specific event. The load balancer module evaluates the current state of all printing stations associated with the event, considering: the number of jobs and copies in each station's queue, the online/offline status of each station (determined by heartbeat signals), the printer status at each station (including paper and ink levels, and any error conditions reported by the printer), and the pause status of each station (both manual and automatic pauses due to errors).
c) Station Selection and Job Dispatch: The load balancer selects the least busy, available station based on the criteria outlined above. If no stations are available, the job remains in the queue with a “Pending” status. Upon station selection, the server transmits a print job message to the chosen station via a secure, bidirectional communication channel. This message includes: a unique Job ID generated by the server, a unique URL that was generated for the image, the number of copies, the guest ID, and the event ID.
d) Station Acknowledgment, Download, and Print Preparation:
   i. Acknowledgment 1 (Job Received): The station's Communication Layer acknowledges receipt of the print job by sending an “Ack 1” message to the server, including the Job ID. The server monitors stations responses, if no acknowledgment is received, an automatic retry mechanism is triggered.
   ii. Job Persistence: The station's Job Management Layer then persists the received job details to a local persistent storage, ensuring job persistence across potential station restarts or interruptions.
   iii. Image Download: The Job Management Layer initiates an asynchronous download of the image data from the provided URL using an HTTP client. The downloaded image is stored locally on the station's computing device within a dedicated directory. The local file path is then associated with the print job. If the download fails, the Job Management Layer retries the download up to a defined limit. If all download attempts fail, the station sends a failure notification to the server.
   iv. Acknowledgement 2 (Download Complete): Upon successful image download and preparation, the station sends a second acknowledgment (“Ack 2”) to the server, confirming its readiness to print. This acknowledgment also includes the Job ID. The server updates the job's status to “Downloaded” in the database.
e) Print Execution, Monitoring, and Acknowledgment:
   i. Print Initiation: The Job Management Layer dispatches the print job (including the local file path and number of copies) to the Printer Control Layer.
   ii. Printer Control and Monitoring: The Printer Control Layer interfaces with the printer, sending the appropriate print commands along with any necessary printer-specific settings. It actively monitors the printer's status throughout the print process. If an error is detected, the station pauses its queue, logs the error locally, and transmits a status update (including error details) to the server.
   iii. Copy-Level Retry Mechanism: The Printer Control Layer implements a retry mechanism for each copy of the print job. If a print error occurs on a specific copy, the Printer Control Layer will retry printing that copy up to a predefined limit before considering the entire job failed.
   iv. Acknowledgment 3 (Print Complete/Failed): Upon successful completion of all copies, the Printer Control Layer notifies the Job Management Layer, which sends a final acknowledgment (“Ack 3”) to the server. If the job fails despite retries, a failure notification is sent instead. This final acknowledgment always includes updated status information, including printer status, queue status, and consumable levels, effectively serving as a heartbeat signal. The server updates the print job status to “Printed” or “Failed”.
f) Guest Notification: The server updates the job status in its database and notifies the guest about the outcome (success or failure) of their print request via a real-time update pushed to the guest's mobile device interface. In case of successful printing, the notification includes the station's location for print retrieval. For pending jobs, the server will send periodic updates to the guest regarding the estimated wait time.

Robust recovery mechanisms are implemented at both the server and station levels to ensure continuous operation and minimize disruption in the event of unforeseen interruptions, such as power outages, network issues, or software crashes. These mechanisms are designed to seamlessly restore functionality and maintain data integrity, guaranteeing reliable print delivery even under adverse conditions. The server recovery process (illustrated in the “Server Recovery” subgraph of FIG. 3) involves the following steps:
a) Server Recovery: The server's recovery process is crucial for maintaining the integrity of the print queue and ensuring that pending jobs are not lost during an interruption. The following steps outline the server's recovery procedure:
   i. Pending Job Retrieval: Upon server restart or recovery, the server queries the database for all print requests associated with the specific event and marked with a status of “Pending,” “Received,” or “Downloaded.” This query retrieves the essential job details (image URL, copies, guest ID, event ID, station ID) as well as relevant timestamps (created, received at station) and the retry count.
   ii. Job Status Evaluation and Reassignment: The server evaluates the retrieved jobs and performs the following actions:
      1. Pending Jobs: Jobs with a “Pending” status are re-added to the event's print queue. The server's load balancer then dynamically reassigns these jobs to available stations, considering queue lengths, online status, printer status, and pause status, ensuring efficient distribution across active stations.
      2. In-Progress Jobs (Received or Downloaded): Jobs marked as “Received” or “Downloaded” indicate that a station had already started processing them. The server checks the online status of the originally assigned station.
   If the station is online: The server re-establishes communication and expects the station to re-synchronize its state and resume processing the job from the last acknowledged stage (download or print). No immediate action is taken by the server regarding these jobs; the responsibility for resuming or reporting failure lies with the reconnected station.
   If the station is offline: The server changes the job status back to “Pending” and adds it back to the general event queue. This allows the load balancer to reassign the job to a different available station, preventing it from being indefinitely stalled.
   iii. Resumption of Normal Operation: After handling all recovered jobs, the server resumes typical operation, accepting new print requests, managing the queue, and continuously monitoring station statuses. All recovery actions are logged for auditing and troubleshooting purposes.
b) Station Recovery: The station software is designed to automatically reconnect to the server and resynchronize its print queue after a restart or network disruption. The key steps involved in station recovery (depicted in summary under the “Station Recovery” subgraph of FIG. 3) are:
   i. Communication Layer Reconnection: The Communication Layer attempts to re-establish a connection with the server. It uses an automatic, persistent reconnection strategy with exponential backoff to handle transient network issues. Upon successful reconnection, the station transmits its ID to the server for identification and an authentication takes place.
   ii. Job Management Layer Synchronization: Once connected, the station's job management component restores its state from local persistent storage and receives jobs from the server.
      1. Status Retrieval from Local Persistent Storage: The station retrieves all previously saved print jobs and their corresponding statuses from local persistent storage. This information is used to rebuild the station's internal print queue. Jobs are categorized based on their saved status (e.g., “Received,” “Queued for Printing,” “Printed,” “Failed”).
      2. Job Processing: The station begins processing jobs that were retrieved from persistent storage and marked as “Queued for Printing.” New jobs received from the server are also added to the print queue.
      3. Print Execution and Acknowledgment: The station continuously processes jobs from its internal print queue. For each job:
   Jobs from Persistent Storage: The station checks the job's status. If marked as “Received,” the station downloads the associated image data and then prints. If marked as “Queued for Printing,” the station assumes the download was previously completed and proceeds directly to printing. The station sends appropriate acknowledgments (e.g., “Printed,” “Failed”) to the server. Successfully printed jobs are tracked in a “Printed” list and failed jobs are tracked in a “Failed” list. After processing, job information is removed from persistent storage.
   New Jobs from Server: For new jobs received from the server, the station downloads the associated image data, saves the job and its status (“Received”) to persistent storage, and adds the job to its internal print queue. Once printed, the same acknowledgment and tracking process described above is applied.
   iii. Heartbeat and Status Updates: The station resumes sending regular heartbeats to the server, providing status updates on the printer, queue, consumable levels, and recent job statuses. These heartbeats and status updates enable the server to maintain an accurate view of the station's operational state.

The system incorporates a comprehensive error handling strategy distributed across the server and station software. This strategy addresses potential issues at each stage of the print process, ensuring robust operation and minimizing disruptions to the guest experience.
a) Communication Layer Error Handling: The Communication Layer, responsible for the critical server-station connection, implements the following error handling procedures:
   i. Connection Loss Detection: The Communication Layer continuously monitors the connection status. If a connection loss is detected, it triggers an immediate reconnection attempt.
   ii. Automatic Reconnection Attempts: A persistent reconnection mechanism attempts to re-establish the connection with the server using an exponential backoff strategy. This helps to prevent overloading the server during network outages and allows the station to gracefully handle temporary connectivity issues.
   iii. Job Request Revalidation: Upon reconnection, the station software revalidates any pending or in-progress jobs with the server to ensure data consistency and prevent duplicate printing. This involves checking the latest job status from the server's perspective and reconciling any discrepancies with the station's local status.
b) Job Management Layer Error Handling: The Job Management Layer handles errors related to job processing and data management within the station:
   i. Failed Download Retry Logic: If an image download fails, the Job Management Layer implements a retry mechanism with a configurable number of attempts and increasing delays between retries. This helps to overcome transient network issues or temporary unavailability of the image source. If all retries fail, the job is marked as failed, and the station notifies the server.
   ii. Queue State Persistence: The Job Management Layer continuously persists the state of the print queue to a local database. This ensures that in case of a station restart or crash, the queued jobs are not lost and can be recovered upon restarting the station software. The persistent data includes the job ID, image URL, number of copies, download status, and any error information.
   iii. Error Status Tracking: The Job Management Layer maintains a detailed record of any errors encountered during job processing. This information is logged locally and transmitted to the server via status updates. This comprehensive error tracking facilitates troubleshooting and identification of recurring problems.
c) Printer Control Layer Error Handling: The Printer Control Layer interacts directly with the printer and handles printer-specific errors:
   i. Printer Error Detection: The Printer Control Layer actively monitors the printer status for any error conditions reported by the printer (e.g., out of paper, ink low, paper jam).
   ii. Maintenance Task Scheduling: Based on printer usage or detected issues, the Printer Control Layer can schedule and execute necessary maintenance tasks such as cleaning cycles or calibration routines.
   iii. Error Status Reporting: Detected printer errors are logged locally and reported to the Job Management Layer, which in turn relays this information to the server via the Communication Layer. The error reports include error codes and descriptions provided by the printer.

The server employs a continuous station monitoring system to maintain an up-to-date view of each station's operational state and resource availability. This real-time monitoring (shown in the “Continuous Monitoring” subgraph of FIG. 3) enables proactive error handling, efficient load balancing, and optimized resource management.
a) Heartbeat Mechanism: Stations periodically send heartbeat messages to the server. These heartbeats always include a comprehensive status update and serve as the primary means of communication between the station and server regarding real-time status. If a station fails to send a heartbeat within a defined timeout period (currently 10 seconds), the server marks the station as offline. The station's online/offline status is continuously tracked by the server.
b) Status Updates (Included in Heartbeat): Every heartbeat transmitted by the station includes a detailed status update encompassing the following information:
   i. Printer Status: The current operational state of the printer (e.g., idle, printing, paused, offline, error), enabling the server to make real-time decisions about job assignments. This includes specific error codes and human-readable descriptions provided by the printer, allowing for detailed diagnostics.
   ii. Consumable Levels: Current ink and media levels, reported as a percentage of remaining capacity or estimated remaining prints. This allows the server to monitor consumable usage and proactively alert operators about low levels.
   iii. Last Jobs Status: Lists of the IDs of the last 5 successfully printed jobs and the last 5 failed jobs. This aids in reconciling server records with the station's internal state and allows the server to detect any processing discrepancies or failures. These lists are included in every heartbeat, ensuring the server has continuous access to recent job history.
   iv. Station Pause Status: A Boolean flag indicating whether the station's job processing queue is currently paused, either manually by an operator or automatically due to an error condition. This status is crucial for the server's load balancing algorithm to avoid assigning jobs to paused stations.
c) Automatic Resource Management: The server leverages the detailed status updates received via heartbeats to perform automated resource management:
   i. Consumable Level Monitoring: The server continuously monitors the ink and media levels reported by each station. This real-time monitoring facilitates predictive maintenance and allows for timely intervention before consumables run out, minimizing potential disruptions during events.

The described printing station, therefore, introduces a novel approach to decentralized event photo printing. The innovative combination of a local computing device, connected printer, and layered software architecture with secured communication that facilitates autonomous operation while seamlessly integrating with the broader system. The station's ability to persistently store job status locally and recover from interruptions, combined with robust error handling within each software layer, ensures reliable and uninterrupted printing even under challenging conditions. This focus on reliability and autonomous operation, coupled with efficient resource management and real-time status reporting, contributes to a more efficient and robust printing experience.

### The Management System

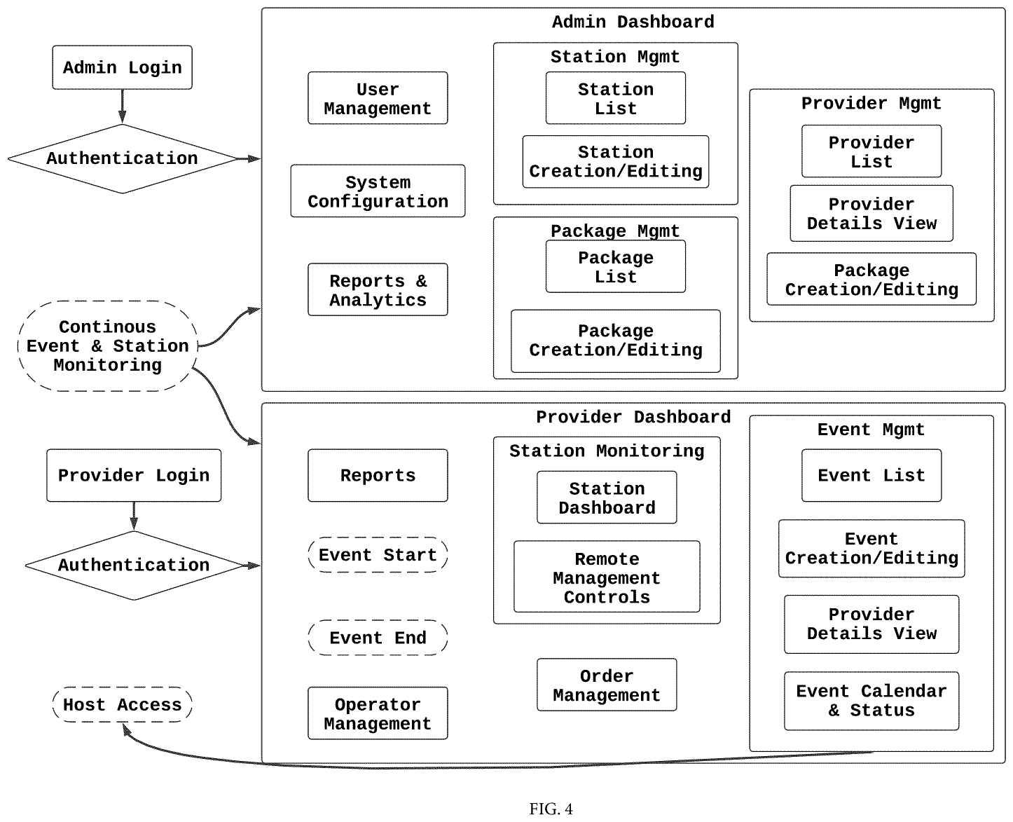

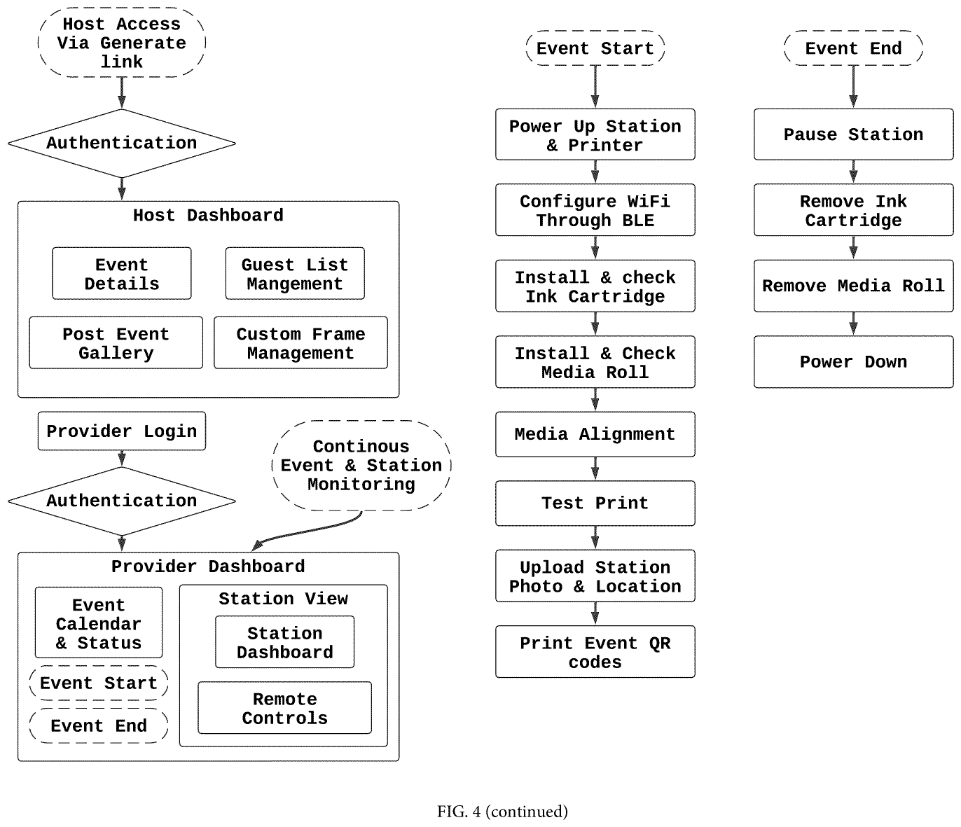

Referring now to FIG. 4, The management and operational aspects of the disclosed system are facilitated through dedicated user interfaces tailored to the distinct roles within the system: Administrator, Provider, Operator, and Host. These interfaces provide authorized users with the tools and information necessary to manage events, configure settings, monitor station status, interact with guests, and analyze system performance. The following sections detail the functionalities and features of each user interface.

Administrator Interface: The Administrator interface provides comprehensive tools for managing all aspects of the photo booth system. The UI is structured around a central dashboard, offering access to various functionalities organized by categories for intuitive navigation.

A. Dashboard and Navigation: Upon logging in using secure authentication protocols, the Administrator is presented with a central dashboard. A navigation menu, either positioned horizontally or vertically, categorizes the Administrator's functionalities into the following sections:
i. Administrators User Management: For managing Administrator users.
ii. Provider Management: For handling provider accounts and configurations.
iii. Package Management: For creating and customizing photo booth packages.
iv. Station Management: For registering, assigning, and monitoring stations.
v. System Configuration Options: For configuring system-wide settings, AI templates, and virtual prop libraries.
vi. Reports and Analytics: For accessing system usage reports and analytics.

B. Administrators User Management:

This section offers a dedicated interface for managing administrators accounts The UI includes:
i. User List: A table displaying all registered administrator users with key information such as name, role, email.
ii. User Creation/Editing: A form for creating new users or editing existing ones. This form includes fields for name, email, phone number, password, and role assignment.

C. Provider Management:

This section focuses on managing provider accounts and configurations. The UI comprises:
i. Provider List: A table displaying all registered providers with their name, contact information, provider type assigned, and current status (active/inactive). By clicking on a dedicated button in the table, the administrator can access a provider's dashboard and perform actions within the system that the provider is authorized to carry out.
ii. Provider Details View: A dedicated view for each provider, displaying detailed information about their account, including:
   1. Profile: Provider name, contact information, address, website URL, and assigned provider type.
   2. Users: A list of users associated with the provider account, with options to add, edit, or remove users.
   3. Packages: A list of packages offered by the provider, allowing the Administrator to view or adjust the provider's offerings.
   4. Stations: A list of stations assigned to the provider, enabling the Administrator to manage station allocations and track their status.
iii. Provider Creation/Editing: A form for creating new provider accounts or editing existing ones. This form includes fields for all the information displayed in the Details View, as well as options to configure the provider's operational model (Venue, Freelance, Limited Freelance, Business) and income share percentage.

D. Package Management:

This section facilitates the creation and customization of photo booth packages. The UI includes:
i. Package List: A table displaying all available package templates, showing their name, price, included features, print credit distribution rules, and status (active/inactive).
ii. Package Creation/Editing: A form for creating new package templates or modifying existing ones. This form allows the Administrator to configure various parameters:
   1. Basic Information: Package name, description, and price.
   2. Print Allocation: Total number of prints allowed, supported media types (photo paper, magnetic), and print credit distribution rules (dynamic or fixed allocation).
   3. Feature Availability: Enable or disable features like basic photo capabilities, virtual props, custom frames, AI-powered enhancements, and SMS notifications for guests.
   4. AI Template Configuration: For AI-powered features, style options.

E. Station Management:

This section within the Administrator Interface provides tools for registering new stations, managing their assignment to providers, and monitoring their operational status. The UI comprises the following:
i. Station List: A table displays all registered stations, listing their name, unique Station ID (UUID), Bluetooth Low Energy (BLE) Challenge Key, assigned Provider, printer type, and the Remote Connection ID. This list serves as a central hub for managing all stations within the system.
ii. Station Creation/Editing: A dedicated form enables the registration of new stations. This form includes fields for:
   1. Station Name: A descriptive name for the station.
   2. Station ID (UUID): A unique identifier for the station, which can be automatically generated.
   3. Provider: A dropdown menu to select the Provider to whom the station is assigned.
   4. Printer Type: A selection field to specify the type of printer connected to the station.
   5. Remote Connection ID: An identifier used for remote communication and management of the station using a remote access software.
   6. BLE Challenge Key: A security key used for authenticating BLE connections during WiFi setup. This key can also be automatically generated.

F. Virtual Prop Library: Upload, categorize, organize, and manage virtual props for guest use, providing a diverse library to enhance personalized experiences. Include a simple grid view with navigation buttons at the top to switch between prop categories, drag-and-drop functionality for reordering, the ability to delete props directly from the grid, and a creation dialog for adding new props.

G. Settings:

This section allows the Provider to manage standard account settings and preferences (e.g. changing password).

The Administrator interface, as depicted in FIG. 4 and described above, provides a centralized and robust platform for managing all aspects of the photo booth system. Its intuitive design, organized navigation, and comprehensive functionalities empower the Administrator with complete control over users, providers, packages, stations, system settings, and data analysis.

Provider Interface:

The Provider interface, as shown in FIG. 4, provides a streamlined workflow for managing events, equipment, operators, and analyzing event data. The system supports four distinct provider operational models tailored to different business structures and service offerings: Venue, Freelance, Limited Freelance, and Business. This allows for customized interface experiences and functionalities based on the provider's chosen operational model. The UI is further tailored to the needs of photo booth providers, allowing them to efficiently handle their operations and interact with other system users (hosts and operators). A key advantage of this system is its hands-off operation, minimizing setup time and on-site management, unlike traditional photo booths which often require continuous attendance.

There are four operational models:

Venue: Ideal for fixed-location venues like banquet halls or event spaces. Venues can offer the photo booth service with minimal effort, leveraging the system's automated features. Events are easily configured within the system, allowing minimum burden on the venue staff. This model allows venues to generate additional revenue streams with minimal hands-on involvement.

Freelance: Designed for mobile photo booth providers. The system streamlines event setup and management, allowing freelance providers to efficiently handle multiple events. The intuitive interface and automated features minimize on-site configuration time, enabling the provider to focus on guest interaction and other value-added services. This hands-off approach significantly reduces operational overhead compared to traditional photo booths, which often require constant adjustments and monitoring.

Limited Freelance: This model empowers providers offering virtual photo booth experiences or other services not requiring on-site printing. By eliminating the need for physical stations and on-site staff, this model maximizes operational efficiency and minimizes logistical complexities. Providers can leverage the system's features for image capture, customization, and online sharing without the overhead of physical equipment.

Business: Suitable for businesses seeking seamless integration of the photo booth system into their existing operations. This model offers continuous, hands-off operation without the need for event-specific configurations. Businesses can leverage the system for various applications, such as customer engagement, product promotion, or data collection, benefiting from the automated features and minimal management requirements.

A. Dashboard and Navigation:

The Provider dashboard provides real-time information and quick access to crucial functions:
i. Upcoming Events: A calendar view or list displaying upcoming events, including those occurring at the current time. Each entry provides a link to detailed event information.
ii. Active Stations: Dashboards for the stations of the events currently underway.
iii. Current Event Metrics: For events in progress, the dashboard displays relevant metrics such as:
   1. Guests Logged In: The number of guests who have successfully accessed the photo booth experience.
   2. Photos Taken: The total number of photos captured during the event.
   3. Shares: The number of photos shared by guests.
   4. Downloads: The number of photos downloaded by guests.
   5. Prints: The total number of prints made.
iv. Current Event Management (described in detail under [0144]-[0147]):
   1. Start Event: Initiates the guided setup process for the assigned station(s).
   2. End Event: Triggers the guided teardown process for the assigned station(s).
   3. Consumables Change: Access to processes for changing consumables.

A navigation menu, often located on the side of the interface, organizes the Provider's functionalities:
i. Events: For managing upcoming and past events.
ii. Stations: For monitoring and managing assigned stations.
iii. Operators: For managing assigned operators (if applicable).
iv. Orders: For placing orders for supplies and consumables.
v. Reports: For accessing event and performance reports.
vi. Settings: For managing account settings, billing information, and other preferences.

B. Events Management:

This section is the core of the Provider interface, allowing providers to create, manage, and track events. The UI includes:
i. Event List: A table displaying all upcoming and past events for the provider. The table shows key information such as event name, type, date, time, location, assigned package, host contact details, and operator assignment (if applicable).
ii. Event Creation/Editing: A form for creating new events or modifying existing ones. This form includes:
   1. Basic Information: Event name, event type (e.g., wedding, corporate event), event start and end date/time.
   2. Package Selection: A dropdown menu to select the desired package for the event. The interface dynamically displays the details and pricing of each package to aid the provider's selection.
   3. Host Information: Fields for entering the host's name, email, and phone number, as well as an option to automatically generate a unique access code for the Host interface. The Provider can also choose to manually enter an access code.
   4. Operator Assignment (optional): If the Provider has enabled operators for their account, a dropdown menu appears, allowing them to assign an available operator to the event.
   5. Station Assignment: A section to select the station(s) to be used for the event. The interface shows the availability and location of each station, allowing the Provider to choose the most appropriate option.
iii. Event Details View: A dedicated view for each event, providing comprehensive information and management options:
   1. Event Summary: Displays the event's basic information, including name, type, date, time, location, and package.
   2. Host Details: Shows the host's contact information and the generated access code for the Host interface. allows Creation/Editing of hosts.
   3. Operator Details: If an operator is assigned, their contact information and scheduling details are displayed.

C. Stations Management:

This section offers a centralized view and management dashboards for all stations assigned to the provider. The UI features:
i. Station Dashboard: A grid displaying all assigned stations. Each station card or entry shows:
   1. Station Name: The designated name of the station.
   2. Station Status: Online/offline status, current status (e.g. printing, idle), location.
   3. Real-time Status: A constantly updating display of the station's current state, Online/offline status, printer status (e.g. printing, idle etc.), and error messages (if any).
   4. Consumable Levels: Visual indicators (e.g., progress bars) for ink and media levels, with automated alerts for low levels.
   5. Print Queue Status: Number of pending print jobs and estimated completion time.
   6. Remote Management Controls: Buttons to remotely manage the station:
   6.1 Print Alignment Page: Initiates the printing of an alignment page for calibrating the station.
   6.2 Eject Media: Commands the station to eject the current media.
   6.3 Restart/Shutdown Station: Allows the provider to remotely restart or shut down the station.
   6.4 Upload Station Photo: Enables uploading a new station photo for display in the guest interface.

D. Operator Management (Optional):

If the provider has enabled Operator accounts, this section provides tools for managing them:
i. Operator List: A table displaying all operators associated with the provider, showing their names, contact information, availability, and assigned events.
ii. Operator Creation/Editing: A form for creating new operators or modifying existing ones.
iii. Operator Details View: A dedicated view for each operator, displaying their profile information, availability calendar, and assigned events.

E. Order Management:

This section facilitates the ordering of consumables and supplies for the provider's stations. The UI includes:
i. Order History: A list of past orders with their date, status (e.g., pending, shipped, delivered), and associated invoice information.
ii. Order Tracking: Functionality to track the status of placed orders.

A consumables order (printing media/ink) order is automatically created once a certain threshold is hid, the system updates the stock every time printing media/ink is changed in a printer.

F. Reports and Analytics

This section provides tools for analyzing event data and tracking provider performance. The UI includes:
i. Event Reports: Generate detailed reports on individual events, including:
   1. Guest Participation: Total guests logged in, average session duration, and demographics (if collected).
   2. Photo Booth Usage: Total photos taken, prints made, shares, and downloads.
   3. Revenue: Total revenue generated from prints and any additional services.
   4. Guest Feedback: Guest satisfaction ratings and comments (if collected).
ii. Performance Dashboard: Displays an overview of the provider's key performance indicators (KPIs), such as total events hosted, overall revenue, average revenue per event, total prints, and customer satisfaction trends.

G. Settings:

This section allows the Provider to manage standard account settings and preferences (e.g. changing password).

The Provider interface, as illustrated in FIG. 4 and detailed above, provides a user-friendly and comprehensive toolkit for managing photo booth operations. Its intuitive layout, clear navigation, and robust functionalities empower providers to efficiently handle events, stations, operators, and analyze their performance.

Operator Interface:

The Operator interface, as depicted in FIG. 4, is designed for on-site event management and provides operators with the necessary tools to control and monitor assigned photo booth stations. The UI emphasizes real-time station status, print job management, and streamlined workflows for starting and ending events.

A. Dashboard and Navigation:

The Operator dashboard focuses on the current event and provides at-a-glance information about assigned stations:
i. Current Event: Prominently displays the name and details of the currently assigned event (if any) with management options.
ii. Assigned Station(s): Shows the status of each station assigned to the current event and enables control of the assigned station(s).

The navigation menu provides access to the following sections:
i. Events: A calendar view or list of assigned events, allowing operators to see upcoming events.
ii. Stations: A dashboard view of assigned station(s) for the current event.
iii. Settings: For managing personal account settings.

B. Current Event Management (described in detail under [0144]-[0147]):
i. Start Event: Initiates the guided setup process for the assigned station(s).
ii. End Event: Triggers the guided teardown process for the assigned station(s).
iii. Consumables Change: Access to processes for changing consumables.

C. Current Event Stations Management:

This section offers a real-time view and control of the assigned station(s) during an event:
i. Station Dashboard: A grid displaying all assigned stations. Each station card or entry shows:
   1. Station Name: The designated name of the station.
   2. Station Status: Online/offline status, current status (e.g. printing, idle), location.
   3. Real-time Status: A constantly updating display of the station's current state, Online/offline status, printer status (e.g. printing, idle etc.), and error messages (if any).
   4. Consumable Levels: Visual indicators (e.g., progress bars) for ink and media levels, with automated alerts for low levels.
   5. Print Queue Status: Number of pending print jobs and estimated completion time.
   6. Remote Management Controls: Buttons to remotely manage the station:
   6.1 Print Alignment Page: Initiates the printing of an alignment page for calibrating the station.
   6.2 Eject Media: Commands the station to eject the current media.
   6.3 Restart/Shutdown Station: Allows the provider to remotely restart or shut down the station.
   6.4 Upload Station Photo: Enables uploading a new station photo for display in the guest interface.

D. Settings:

This section allows the Provider to manage standard account settings and preferences (e.g. changing password).

The Operator interface, as depicted in FIG. 4 and described above, provides an intuitive and efficient way for operators to manage assigned events and stations on-site. Its focus on real-time station status, print job control, and guided setup and teardown processes streamlines the operator's workflow, ensuring a smooth and engaging experience for event guests. Host Interface:

The Host interface, as illustrated in FIG. 4, empowers event organizers with the ability to personalize the photo booth experience for their guests. The interface provides access to event details, frame selection, guest list management, and communication templates, all accessible through a unique, secure link provided by the Provider.

A. Event Access and Authentication:

The Host accesses their dedicated interface via a unique link generated by the Provider during the event creation process. This link may contain a simple token or code for authentication. The link is sent to the host via SMS or email. Upon clicking the link, the Host may be required to enter the access code to authenticate and unlock the event's customization options.

B. Event Details Management:

Upon successful authentication, the Host is presented with a dashboard displaying a summary of the event details, including:

Event Information: Event name, type, date, time, location, and assigned package.

C. Custom Frame Management:

This section enables the Host to add a personal touch to the photo booth experience by selecting or uploading custom frames for the photos:
i. Frame Library: A selection of pre-designed frames categorized by theme or style (e.g., wedding, birthday, corporate). The Host can preview how these frames would look on sample images.
ii. Upload Custom Frame: Functionality to upload custom frames for both horizontal and vertical photos.

D. Guest List and Invitations:

This section facilitates guest management and communication before the event:
i. Guest List Management: The Host can:
   1. Upload Guest List: Import a guest list from a spreadsheet file.
   2. Manually Add Guests: Enter guest information (name, email, phone number) individually.
   3. Edit Guest Information: Update or correct guest details.
   4. Download Guest List: Export the guest list for backup or other purposes.
ii. Invitation Management:
   1. Invitation Templates: Choose from pre-written invitation templates or create custom messages. The templates are designed to be engaging and informative, including details like the event name, date, time, location, and a link to the guest login page.
   2. The invitations are sent based on a predetermined schedule.

E. Post-Event Features:

Upon event completion a gallery with all of the guests' photos becomes available to the host/s. A host can download all captured photos from the event gallery in a convenient format (e.g., ZIP file).

The Host interface, as illustrated in FIG. 4 and described above, empowers event organizers with a user-friendly set of tools to personalize the photo booth experience. From customizing frames to sending invitations and managing the event gallery, the Host interface ensures a unique and memorable experience for guests while maintaining a seamless connection with the Provider's services.

Current Event Management:

FIG. 4 illustrates the Current Event Management, representing the operational workflow during events. This system consists of two primary operational flows: Event Startup and Event Teardown, and a continuous monitoring component. Additionally, it includes dedicated maintenance procedures to ensure smooth operation throughout the event.

A. Event Startup Flow:

The Event Startup Flow outlines the steps to prepare the station for an event, triggered by the Provider or Operator selecting “Start Event”:
1. Power Up Station & Printer: Ensures both the station's computer and printer are powered on and ready.
2. Optional: Configure WiFi Through BLE: Connect the station though BLE to set up the local WiFi network connection if needed, so the station can connect to the cloud server.
3. Install/Check Ink Cartridge: Verifies the presence and status of the ink cartridge, guiding the operator through installation if needed.
4. Install/Check Media Roll: Verifies the presence and status of the media roll, with operator-guided installation if required.
5. Media Alignment: Ensures accurate printing through proper media alignment, which can be manual or partially automated with system guidance.
6. Test Print: A test print verifies print quality and alignment, allowing the operator to adjust if necessary.
7. Upload Station Photo & Location: The operator captures or uploads a photo of the station and provides a location description to guide guests.
8. Optional: Print Event QR Codes: Optionally prints QR codes for guest access or specific functionalities, customizable for table assignments or personalized experiences.

B. Event Tear Down Flow:

The Event Tear Down Flow outlines the steps for safely shutting down and securing the station after an event, initiated by the Provider or Operator selecting “End Event”:
1. Pause Station: Halts printing operations to prevent interruptions during teardown.
2. Remove Media Roll: The operator removes and stores the media roll.
3. Remove Ink Cartridge: The ink cartridge is removed and stored.
4. Power Down: The station's computer and printer are powered down safely.

C. Maintenance Procedures:

C. Maintenance Procedures: Besides the startup and teardown procedures, the Event Management system implements dedicated maintenance workflows to ensure seamless operation throughout the event. Most events need no changes during execution since the setup includes enough consumables. However, there are two maintenance workflows for cases where a change is needed:
i. Change Cartridge Flow: This wizard guides the operator through the process of replacing the ink cartridge. It includes step-by-step instructions for opening the casing, removing the old cartridge, installing a new one, and verifying proper installation.
ii. Change Media Flow: This wizard facilitates the replacement of the media roll. The steps involve ejecting the current roll, loading a new one, ensuring proper alignment, and conducting a test print to confirm successful installation.

D. Continuous Event Monitoring:

The station continuously monitors its status and performance during events, relaying data on resource usage (ink, media, etc.), print job progress, and errors to the Provider and Operator dashboards. This allows for real-time monitoring and proactive maintenance throughout the event.

This multifaceted management system, with distinct interfaces for Administrators, Providers, Operators, and Hosts, is a great innovation of the disclosed system. The clear delineation of roles and responsibilities, coupled with real-time data synchronization and secure authentication, allows for a level of control and flexibility not found in traditional photo booth setups. The system's ability to dynamically manage print jobs across a distributed network of stations, while simultaneously providing personalized experiences through customizable packages and host controls, creates a scalable and user-friendly solution. This integrated approach, encompassing event creation, remote station monitoring, guest interaction, and comprehensive reporting, represents a significant departure from conventional event photography solutions and establishes a new paradigm for interactive, on-demand photo printing.

### Embodiments

The following embodiments describe various implementations of the distributed photo capture and printing system. It should be understood that these embodiments are presented for illustrative purposes only and are not intended to limit the scope of the invention. The system's modular architecture allows for numerous variations and combinations of hardware, software, and deployment configurations, including the addition or removal of specific hardware and software components, all within the scope of the appended claims. Persons skilled in the art will recognize that the specific technologies and components described in each embodiment can be substituted with equivalent alternatives without departing from the spirit and scope of the invention.

### Embodiment 1: Preferred Embodiment

This preferred embodiment describes a cloud-based implementation of the distributed photo capture and printing system, designed for scalability and flexibility for event photography. This implementation is not intended to limit the scope of the invention.

The server-side utilizes a Blazor Server application hosted on Azure App Services. Blazor Server allows for a rich, interactive web user interface by maintaining a persistent connection to the client. This enables real-time updates, such as print job status notifications, directly within the guest and management interfaces. Azure SQL Server provides the relational database for storing event information, user data, etc., offering robust data management capabilities. Image files are stored in Azure Blob Storage, a highly scalable and cost-effective cloud storage service designed for handling large volumes of unstructured data. Communication between the printing stations and the Azure App Services server is facilitated by SignalR, enabling bidirectional, real-time communication for efficient print job management and status updates. Mutual TLS (mTLS) is implemented for secure authentication between the printing stations and the server, ensuring the integrity and confidentiality of communications.

Guests access the system through a web interface rendered by the Blazor Server application. Event-specific URLs or QR codes provide a simple and secure method for guests to join the event's photo experience, ensuring a user-friendly experience without requiring guests to create accounts or remember passwords. Authentication is handled through secure, HTTP cookies.

The management system, also a Blazor Server web application, utilizes the same Azure SQL Server database and Azure Blob Storage as the guest interface, providing a unified data management platform. Access to management functionalities is controlled through role-based access control and secure URLs.

Each printing station utilizes an Intel NUC (or similar mini PC) running Windows OS. The station software, written in .NET Framework, communicates with the cloud-based server via SignalR and mTLS, ensuring secure and reliable data exchange. A local SQLite database on the PC provides persistent storage for the print job queue and status information, enabling the station to handle temporary network interruptions and resume operations seamlessly. The station is equipped with a Primera IP60 inkjet printer, selected for its compact form factor, high-quality print output, speed, and support for both standard photo paper and magnetic media. The printer interfaces with the station software via a USB connection (or other appropriate interface).

This cloud-based architecture allows for dynamic scaling and high availability. The system can handle events of any size by adjusting the server resources and deploying additional print stations as needed. The use of cloud services simplifies system maintenance and updates, while real-time communication ensures a responsive and engaging user experience.

### Embodiment 2: Alternative Full-Featured Cloud Embodiment

This embodiment presents an alternative cloud-based implementation of the event photography system, demonstrating the invention's adaptability to different technologies while maintaining the core functionality and distributed architecture.

The server-side components are implemented using Node.js with the Express.js framework, chosen for its efficiency and widespread use in web application development. This server software is deployed on Google Kubernetes Engine (GKE), which provides a highly scalable and managed environment for containerized applications, allowing for dynamic scaling of resources based on event demands. Data persistence is handled by Cloud SQL, Google Cloud's fully managed relational database service, offering compatibility with various database engines. Images are stored using Google Cloud Storage, a scalable and secure object storage service optimized for diverse data types. Real-time communication between the printing stations and the server is achieved using WebSockets, a communication protocol providing persistent, bidirectional connections. JSON Web Tokens (JWT) are utilized for authentication and authorization, offering a robust and industry-standard security mechanism.

Guests interact with the system through a React web application. React, a popular JavaScript library for building user interfaces, provides a dynamic and responsive user experience. Similar to Embodiment 1, access is granted through event-specific URLs or QR codes, and authentication can be handled through JWT, maintaining a streamlined and secure guest experience.

The management system is also implemented as a React web application, providing a consistent user experience across different user roles. Role-based access control ensures that users have appropriate permissions for managing events, stations, and other system functionalities.

The printing stations in this embodiment utilize a Raspberry Pi 4 (or similar single-board computer) running a Linux operating system. This choice reflects a focus on cost-effectiveness and energy efficiency, particularly suitable for portable or temporary deployments. The station software is implemented in Python, a versatile programming language well-suited for interfacing with hardware and communicating with cloud services. WebSockets are used for communication with the server, maintaining consistency with the server-side technology stack. JWT is used for station authentication. The print queue and job status information are managed using the local file system, offering a lightweight alternative to a local database like SQLite. A DNP RX1HS dye-sublimation printer provides high-quality photo printing capabilities. This printer is chosen for its compact size, speed, and reliable performance, complementing the portable nature of the Raspberry Pi-based station.

This embodiment highlights the flexibility and adaptability of the invention, showcasing the use of a completely different set of technologies while maintaining the core distributed architecture and functionality. The choice of Google Cloud Platform services and the Raspberry Pi-based stations offers a potentially more cost-effective and portable solution, while the use of React and Python demonstrates the system's compatibility with widely adopted web and software development technologies.

### Embodiment 3: Cross-Platform Native Mobile App Client

This embodiment focuses on enhancing the guest experience by providing a dedicated, cross-platform native mobile application while maintaining the cloud-based server infrastructure and printing station setup of Embodiment 1. This demonstrates the flexibility of the system to accommodate different client technologies without requiring significant changes to the server or station components.

The server-side infrastructure remains identical to Embodiment 1: Blazor Server on Azure App Services, Azure SQL Server database, Azure Blob Storage for images, SignalR for server-station communication, and mTLS for server-station authentication. This provides a consistent and reliable backend for handling event data, print job management, and communication with the printing stations. An additional ASP.NET Core API is introduced to specifically serve the .NET MAUI mobile application. This API layer provides optimized data exchange and mobile-specific functionalities for the app, such as push notifications for print job status updates. The API interacts with the existing Blazor Server application and shares the same underlying database and storage resources.

Guests now interact with the system through a native mobile application built with .NET MAUI (Multi-platform App UI). This framework allows for the development of a single codebase that can be compiled into native applications for various platforms, including iOS, Android, Windows, and macOS. This approach offers several advantages over a web-based interface:
1. Enhanced User Experience: Native apps generally provide a more seamless and integrated user experience compared to web apps, taking full advantage of the device's capabilities and user interface paradigms.
2. Offline Capabilities: .NET MAUI enables the implementation of offline functionality, allowing guests to capture and queue print jobs even without an active internet connection. The print jobs are then synchronized with the server once connectivity is restored.
3. Push Notifications: Direct integration with the device's push notification system allows for real-time updates on print job status, eliminating the need for guests to actively check the app.
4. Improved Camera Integration: Native apps typically have better access to device hardware, including the camera. This allows for a more streamlined photo capture experience within the app, with features like autofocus, flash control, and access to different camera modes.

Access to the event photo experience within the .NET MAUI app is granted through event-specific URLs or QR codes, consistent with previous embodiments. Authentication can be handled using various methods, including JWT (JSON Web Tokens) or OAuth 2.0, leveraging industry-standard security protocols for mobile applications.

The management system remains a Blazor Server web application as in Embodiment 1, ensuring consistency for administrative users.

The printing stations also remain identical to Embodiment 1, utilizing Intel NUCs with Windows OS, .NET Framework-based station software, Primera IP60 inkjet printers, SignalR communication, mTLS authentication, and a local SQLite database.

This embodiment demonstrates the flexibility of the system to accommodate a cross-platform native mobile app client, leveraging .NET MAUI for a superior user experience while maintaining compatibility with the existing server and station infrastructure. The introduction of the ASP.NET Core API layer further optimizes the communication between the mobile app and the server, providing mobile-specific features and enhanced performance.

### Embodiment 4: Localized, Narrowed-Down System for Continuous Operation in a Dedicated Facility

This embodiment describes a localized and narrowed-down implementation of the photo capture and printing system specifically designed for continuous operation within a dedicated facility, such as a museum, theme park, or other attraction. This embodiment eliminates the event- based context and associated management roles (Providers, Hosts, Operators) present in previous embodiments, streamlining the system for a single, dedicated purpose within a controlled environment. This embodiment is not intended to limit the scope of the invention.

Instead of a cloud-based server, this embodiment utilizes a local server located within the facility's network. The server software, a containerized version of the Blazor Server application running on Docker, provides a consistent development and deployment environment. This approach simplifies maintenance and updates while offering platform independence. A local instance of SQL Server serves as the database. Images are stored directly on the local server's file system, providing fast access and eliminating reliance on external cloud storage services. All communication within the system, including between the server, the management interface, and the printing stations, occurs over the facility's local network (Wi-Fi or LAN), ensuring low latency and minimizing reliance on external internet connectivity.

Guests interact with the system through a .NET MAUI native mobile application, offering the advantages described in Embodiment 3: enhanced user experience, potential offline capabilities, push notifications, and improved camera integration. Guests initiate the printing process by scanning station-specific QR codes displayed at each printing station. This approach eliminates the need for event-specific URLs and simplifies the user workflow, aligning with the continuous operational mode of this embodiment.

The management interface is a simplified version of the management system from Embodiment 1, accessible only to administrators. This web interface, also a Blazor Server application running on the local server, provides functionalities tailored to managing the dedicated facility's photo printing operations. These functionalities include:
1. Printer Configuration and Management: Adding, removing, and configuring printing stations, including network settings, printer settings (such as media type and print quality), and station location information.
2. System Settings: Configuring global system parameters, such as image enhancement options, print sizes, and data retention policies.
3. Consumable Management (Stock and Auto Orders): Real-time monitoring of ink and media levels at each station, automated low-level alerts, and integrated ordering of consumables. This ensures continuous operation without interruptions due to supply shortages.
4. Usage Analytics: Access to comprehensive reports and analytics on print volumes, popular print options, and other usage patterns, providing valuable insights for optimizing operations and resource allocation within the facility.

The printing stations, similar to Embodiment 1, utilize Intel NUCs (or similar mini PCs) running Windows OS. The station software, a .NET Framework application, communicates with the local server via the internal network. A local SQLite database manages the print queue and persists job status, providing resilience against temporary network or server disruptions. Primera IP60 inkjet printers handle the printing tasks, offering high-quality output and compatibility with various media types.

This localized and narrowed-down embodiment offers a robust and efficient solution for continuous photo printing operations within a dedicated facility. By removing the event-based context and streamlining the management system, this implementation reduces complexity and improves operational efficiency. The use of a local server, containerization, and station-specific QR codes ensures reliability and simplifies system management while maintaining the core advantages of the distributed photo capture and printing architecture.

### Conclusion

The distributed photo capture and printing system described in this patent represents a significant advancement in event photography technology. By leveraging cloud computing, mobile devices, and intelligent printing stations, this invention offers a flexible and scalable solution that addresses many limitations of traditional photo booth systems.

Key advantages of the system include:
1. Scalability: The system can easily accommodate events of varying sizes, from small gatherings to large-scale conferences, without the need for additional physical infrastructure.
2. Distributed Capture: By utilizing guests' own mobile devices, the system eliminates queues and allows for parallel photo capture throughout the event space.
3. Real-time Enhancement: The integration of both digital prop additions and AI-powered enhancements provides guests with a wide range of creative options.
4. Efficient Printing: Load balancing across multiple printing stations, coupled with real-time status updates, ensures optimal use of resources and minimizes wait times.
5. Comprehensive Management: The multi-tiered management system caters to administrators, providers, operators, and hosts, offering tailored interfaces and functionalities for each role.
6. Flexibility: As demonstrated through various embodiments, the system can be adapted to different deployment scenarios, from cloud-based implementations to on-premise solutions for venues with specific security requirements.
7. Integration Potential: The system's architecture allows for easy integration with third-party services, such as social media platforms or advanced analytics tools, expanding its functionality and value proposition.

The invention's modular design and use of modern web technologies ensure that it can evolve with changing technological landscapes and user expectations. Whether deployed in its basic form or as a fully-featured, multi-station configuration, the system provides a superior alternative to traditional photo booths, enhancing the guest experience while offering valuable insights and management tools to event organizers.

In conclusion, this distributed photo capture and printing system represents a paradigm shift in event photography, offering unparalleled flexibility, scalability, and user engagement. Its potential applications extend beyond traditional events, opening possibilities for use in retail environments, tourist attractions, and any scenario where on-demand, high-quality photo capture and printing are desired.

1. A system for on-site photo capture, modification, and printing at time-bound events, scalable to accommodate varying event sizes and demands, leveraging a distributed architecture configured to facilitate parallel photo capture, modification, and printing operations, the system comprising:
a plurality of guest-owned mobile devices, each mobile device comprising:
a processor;
a camera configured to generate digital image data; and
a web browser with access to a cloud-based guest interface;
at least one printing station comprising:
a computer configured to run station software;
a printer configured to produce a physical representation of digital image data;
wherein the station software is configured to communicate in real-time with cloud-based server software via persistent bidirectional communication and receive digital image data and print parameters; and
cloud-based server software configured to:
provide a web-based management interface configured to:
manage the setup and monitoring of the at least one printing station;
manage the creation and modification of time-bound events; and
manage a guest list associated with each event, wherein each entry in the guest list comprises at least one of: an email address and a phone number;
provide the cloud-based guest interface, the guest interface configured to:
communicate in real-time with the cloud-based server software;
transmit digital image data to the cloud-based server software;
provide an interface for modifying the digital image data, the interface enabling at least one of: applying virtual props, applying custom frames, and applying AI-powered style enhancements based on selectable predefined templates, wherein the enhancements preserve the semantic content of the image;
display a personal gallery for images taken at the event;
provide an interface for sending captured images to print; and
provide an interface for downloading and/or sharing captured images;
receive, in real-time, transmitted digital image data from the guest interface of at least one mobile device;
dynamically allocate, in real-time, print jobs to an available printing station based on real-time station availability and queue length to minimize wait times;
receive, in real-time, feedback from the station software regarding the status of each print job and communicate, in real-time, the feedback to the relevant mobile device via the guest interface, including a time estimation for print readiness; and
generate a per-event unique access link to the guest interface, distributable to guests via at least one of: text messages, emails, and QR codes.

2. The system of claim 1, wherein the management system is a part of a downloadable software application installed on a mobile device or computer.

3. The system of claim 1, wherein the management system provides access to an event gallery composed of pictures taken by the guests.

4. The system of claim 3, wherein the management system is configured to allow the creation or upload of custom virtual frames; and wherein the guest interface is configured to dynamically overlay the custom virtual frames onto displayed images without modifying the underlying image data; and wherein the printing station is configured to permanently apply the selected custom virtual frame to the image print; and wherein the management system is configured to allow displaying and/or downloading of images with and without the custom virtual frames.

5. The system of claim 1, wherein the guest interface is a part of a downloadable application installed directly on the mobile devices.

6. The system of claim 1, wherein the station's printer produces a physical representation of the communicated image data on a printing media comprising a magnet, suitable for display on a ferromagnetic material.

7. The system of claim 1, wherein the guest interface, and/or the cloud-based server software, and/or the printing station is configured to embed promotional content into the digital images, the promotional content comprising at least one of: a logo, a watermark, a branded frame, a promotional message, and a website address, based on the identity of at least one of: the service provider, the event host, and a sponsor of the event.

8. The system of claim 1, wherein the cloud-based server software is replaced by a server software within a local area network, said local area network server is configured to perform the functions of the cloud-based server software within a defined local network environment.

9. The system of claim 1, wherein the system operates continuously and is not limited to time-bound events, and wherein the cloud-based server software is configured to operate without event management functionality.

10. The system of claim 1, wherein the management system tracks and monitors the consumption of ink and printing media at each printing station through the cloud-based server software and/or the printing station software, providing real-time monitoring of stock levels and initiating automated ordering of supplies when predefined thresholds are reached.

11. A method for on-site photo capture, modification, and printing at time-bound events, scalable to accommodate varying event sizes and demands, leveraging a distributed architecture configured to facilitate parallel photo capture, modification, and printing operations, the method comprising:
providing a plurality of guest-owned mobile devices, each mobile device comprising a processor, a camera, and a web browser;
accessing a cloud-based guest interface via the web browser on at least one mobile device;
generating digital image data using the camera of the accessed mobile device;
transmitting the generated digital image data to cloud-based server software via the guest interface;
modifying the digital image data via the guest interface, the modification comprising at least one of: applying virtual props, applying custom frames, and applying AI-powered style enhancements based on selectable predefined templates, wherein the enhancements preserve the semantic content of the image;
sending a print request for the modified digital image data via the guest interface;
providing at least one printing station comprising a computer and a printer, wherein the computer is configured to execute station software;
dynamically allocating the print job, by the cloud-based server software, to an available printing station based on real-time station availability and queue length;
communicating, by the cloud-based server software, the digital image data and print parameters to the allocated printing station via persistent bidirectional communication between the station software and the cloud-based server software;
producing, by the printing station, a physical representation of the received digital image data;
receiving, by the cloud-based server software, real-time feedback from the station software regarding the status of the print job;
communicating, by the cloud-based server software, the received feedback, in real-time, to the mobile device that initiated the print job via the guest interface, the feedback including a time estimation for print readiness; and
providing access to a management interface configured for managing the setup and monitoring of the printing station(s); for managing the creation and modification of time-bound events; and for managing a guest list associated with each event, wherein each entry in the guest list comprises at least one of an email address and a phone number; and wherein the management interface is used to generate a per-event unique access link to the guest interface, distributable to guests via at least one of text messages, emails, and QR codes.

12. The method of claim 11, further comprising managing the system via a downloadable software application installed on a mobile device or computer.

13. The method of claim 11, further comprising accessing, via the management interface, an event gallery composed of pictures taken by the guests.

14. The method of claim 13, further comprising:
creating or uploading custom virtual frames via the management interface;
dynamically overlaying, by the guest interface, the custom virtual frames onto displayed images without modifying the underlying image data;
permanently applying, by the printing station, the selected custom virtual frame to the image print; and
providing, by the management interface, access to displaying and/or downloading of images with and without the custom virtual frames.

15. The method of claim 11, wherein accessing the guest interface is performed through a downloadable application installed directly on the mobile devices.

16. The method of claim 11, wherein producing the physical representation comprises printing, by the printing station, the received digital image data on printing media comprising a magnet, suitable for display on a ferromagnetic material.

17. The method of claim 11, further comprising embedding promotional content into the digital image at at least one of: the guest interface; the cloud-based server software; and the printing station, the promotional content comprising at least one of: a logo, a watermark, a branded frame, a promotional message, and a website address, based on the identity of at least one of: the service provider, the event host, and a sponsor of the event.

18. The method of claim 11, wherein the cloud-based server software is replaced by server software within a local area network, said local area network server performing the functions of the cloud-based server software within a defined local network environment.

19. The method of claim 11, wherein the system operates continuously and is not limited to time-bound events, and wherein the server software operates without event management functionality.

20. The method of claim 11, further comprising:
tracking and monitoring, by at least one of the cloud-based server software and the printing station software, the consumption of ink and printing media at each printing station;
providing real-time monitoring of stock levels via the management interface; and
initiating, by at least one of the cloud-based server software and the printing station software, automated ordering of supplies when predefined thresholds are reached.
